(19) United States
(12) Patent Application Publication
(10) Pub. No.: US 2019/0257469 A1
(43) Pub. Date: Aug. 22, 2019

(54) ARTICLE MOUNTING DEVICE

(71) Applicant: 3M INNOVATIVE PROPERTIES COMPANY, St. Paul, MN (US)

(72) Inventors: Sabeel Ullah, High Wycombe (GB); Jason A. Graves, Darlington (GB)

(21) Appl. No.: 16/315,133

(22) PCT Filed: Jun. 30, 2017
(86) PCT No.: PCT/US2017/040245

§ 371 Date: Jan. 3, 2019

(30) Foreign Application Priority Data
Jul. 4, 2016 (GB) 1611655.0

(51) Int. Cl. F16M 13/02

(52) U.S. Cl. CPC F16M 13/022; F16C 11/106; F16M 2200/022

(57) ABSTRACT

An article mounting device including a stretch releasable adhesive strip capable of being attached to a surface. The adhesive strip is positioned on the base, whilst the non-adhesive pull tab portion is visible to allow easy detaching by the user. The mounting device comprises an adjustable protrusion to allow the mounting of a variety of articles to different surfaces such as a wall, ceiling and others.

### FIELD OF THE INVENTION

The present invention relates to a device for mounting or hanging a wide variety of articles such as pictures, decorations, utensils, tools onto a surface.

### BACKGROUND

Pictures, framed photos, and other hanging articles, are normally attached to a wall or ceiling using hooks, clips, hangers and various other support devices. For ease of reference the term “article” will be used herein to refer to the types of articles listed above and which are suitable for use with the device of the present invention. Historically, these mounting devices have been attached directly onto the wall often by way of a nail or screw. This can cause damage to the surface which frequently requires repair if the article is moved removed.

A solution to this problem is the provision of mounting devices having stretch releasable adhesive tape. This type of adhesive facilitates the attachment and detachment of the device to and from the mounting surface with no damage sustained to the surface.

Stretch releasing adhesives are pressure sensitive adhesives that combine strong holding power with clean removal and no surface damage. Stretch releasing adhesives are commonly provided in the form of strips that include an adhesive portion and a non-adhesive pull tab portion that is grasped and pulled by a user during the stretch removal process. An article support device using a stretch releasable adhesive often comprises a base which is configured to be attached to the stretch releasable adhesive tape, in combination with a support body. An example of this device can be found in U.S. Pat. No. 5,409,189.

Often, these mounting devices include a hook, clip, hanger which only have a single angle at which they are orientated relative to the mounting surface. The hook which is required to hang the device is shaped in a way which cannot be adjusted either in its angle relative to the surface on which the article will be mounted or in its length. One example of such a device is disclosed in U.S. Pat. No. 8,708,305. This limitation is problematic because only a limited range of articles can be mounted using a hook with a fixed orientation. The range of articles which can be mounted by an individual article is also limited. For example, the device seen in U.S. Pat. No. 8,708,305 would not adequately hold articles for mounting on a ceiling. Another problem of fixed orientation is that articles cannot be interchanged on the same mounting device.

Accordingly, there is limited freedom with these mounting devices with both the surface on which they can be mounted, the range of articles that can be mounted, and the orientation in which the articles can be mounted.

An object of the disclosure is to mitigate at least some of the problems described above.

### SUMMARY

According to the disclosure there is provided an article mounting device, comprising:
a base having a first major side and second major side;
the first major side comprising a first major surface that is attached to a stretch releasable adhesive strip having an adhesive portion and a non-adhesive pull tab portion;
the second major side comprising a rigid protrusion for receiving an article;
wherein the protrusion is adjustable relative to the base.

Advantageously, the adjustable protrusion provides various angles and lengths relative to the base. This is an advantage because it eliminates the need for angle-specific hanging devices.

In presently preferred implementations, the protrusion is releasably attached to an adjustable mount having a first and second portion wherein the first portion comprises the protrusion.

In presently preferred implementations, the device comprises a position locking mechanism.

Advantageously, the position locking mechanism can ensure the protrusion can be locked into place. This allows the article to be securely mounted in the specified location and at a specified angle. This is an advantage because it allows the angle of the protrusion to be tailored to the article to be hung. This reduces the risk of the article becoming detached from the device. This can be of particular importance for certain heavier articles. Also, security of the mounting device can be of particular importance for certain valuable items, thereby preventing damage caused to the item in the event of the item becomes detached from the device.

In presently preferred implementations, the adjustable mount is a ball- and-socket joint.

Advantageously, a ball and socket joint provides a wide range of angles at which the protrusion can be fixed relative to the article. Furthermore, the ball portion of the joint allows for smooth rotation of the attached protrusion.

In presently preferred implementations, the base comprises the socket of the ball-and-socket joint and the protrusion is attached to the ball of the ball-and-socket joint.

This is an advantage because it allows for easier manufacturing of the article mounting device.

In presently preferred implementations, the ball-and-socket is retained in position by a retaining screw.

In presently preferred implementations, the ball-and-socket joint is retained in position by a locking tab which is located adjacent to the ball-and-socket joint.

In presently preferred implementations, the protrusion is an outwardly protruding headed bolt.

In presently preferred implementations, the adjustable mount comprises a moveable plate.

Advantageously, the protrusion can be moved up and down the length of device again allowing adjustment of the position of the article to be mounted.

In presently preferred implementations, the position locking mechanism comprises a series of notches on the second major side of the base and wherein the moveable plate is secured into the notches

Advantageously, the moveable plate is secured in place to ensure security in the mounting of the article.

In presently preferred implementations, the protrusion has a length which is adjustable.

Advantageously, a protrusion with an adjustable length allows a broad range of articles to be mounted. For example, a large and heavy clock to be mounted may require a longer protrusion to ensure it is securely mounted. However, a small and light kitchen utensil which is mounted using a cord may require a shorter protrusion to be securely mounted. Furthermore, a longer protrusion may not be suitable for aesthetic purposes of some users. This features also allows the device to be repositioned and therefore permits the reuse of the article mounting device.

In presently preferred implementations, second major side of the base comprises a series of markers indicating the central position of the protrusion.

Advantageously, when fixing the article mounting device to a surface the markers may assist the user in positioning the device.

### BRIEF DESCRIPTION OF THE DRAWINGS

FIG. 1 is a front perspective view of a first embodiment of the article mounting device of the present disclosure having a ball-and-socket joint and retaining screw;

FIG. 2 is a rear exploded perspective view of the article mounting device of FIG. 1;

FIG. 3 is a side view of the article mounting device of FIG. 1;

FIG. 4 is a cross section view of the article mounting device of FIG. 1 taken along line in FIG. 1;

FIG. 5 is a front perspective view of a second embodiment of article mounting device according to the present disclosure having a ball-and-socket joint and locking tab;

FIG. 6 is a side view of the article mounting device of FIG. 5;

FIG. 7 is a cross section view of the article mounting device of FIG. 5 taken along line VII-VII in FIG. 5;

FIG. 8 is a front perspective view of a third embodiment of the article mounting device according to the present disclosure having a moveable plate; and

FIG. 9 is a cross section view of the article mounting device of FIG. 8 taken along line IX-IX in FIG. 8.

### DETAILED DESCRIPTION

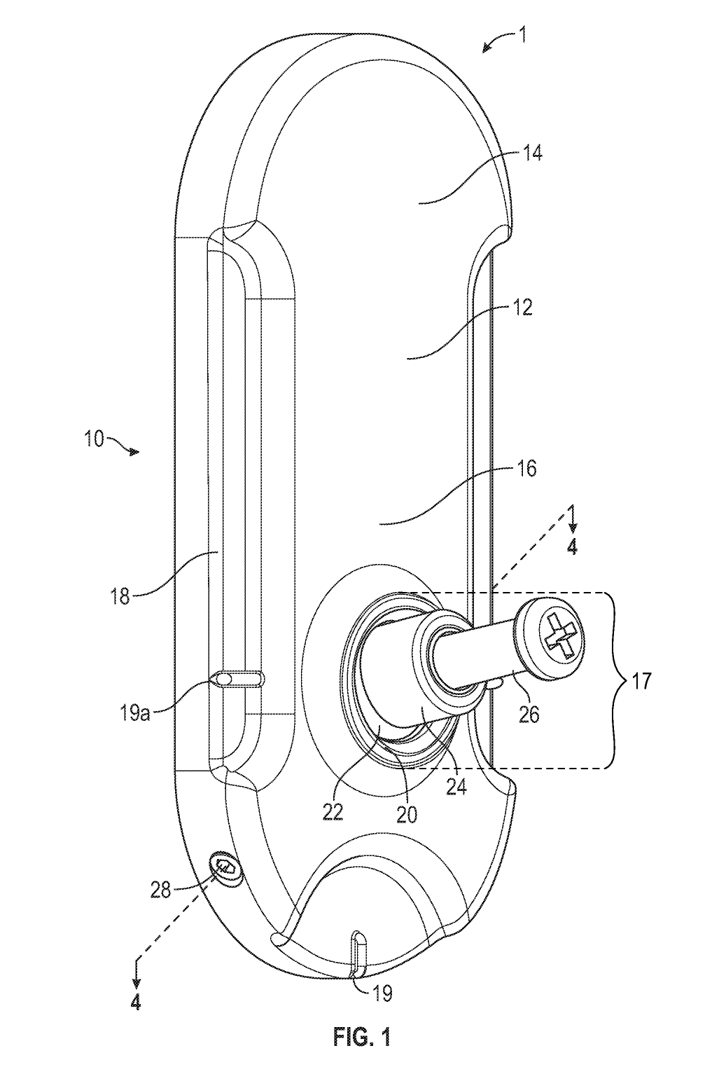

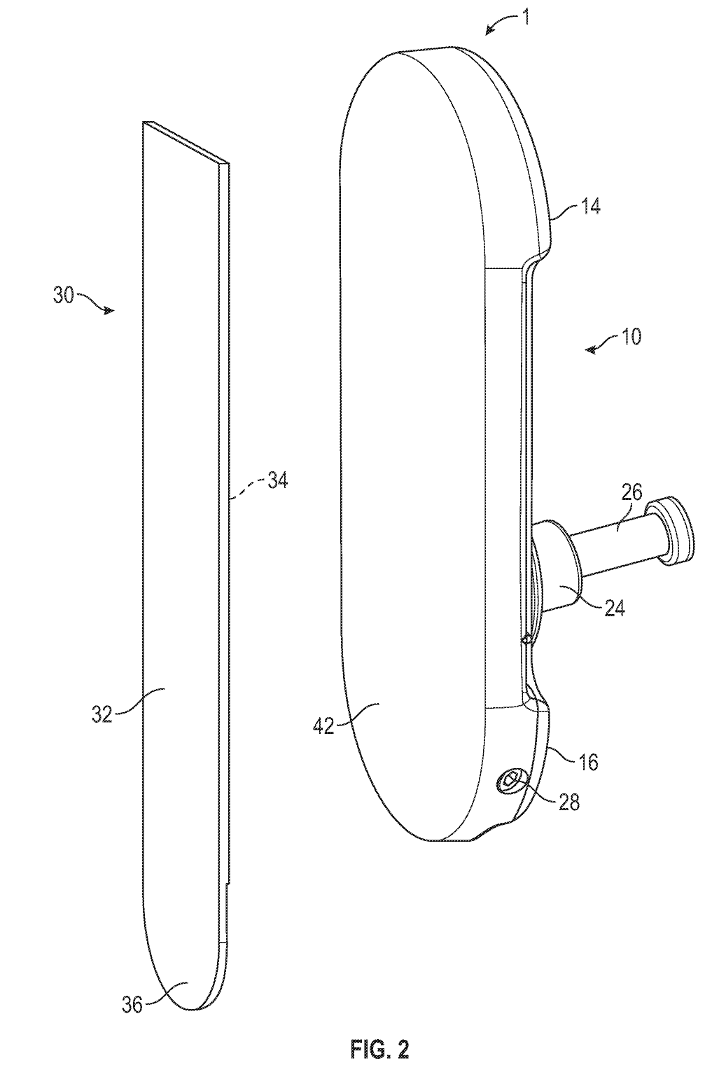

FIG. 1 shows an article support device indicated generally at 1. The device has a base indicated generally at 10 with a first major side 42 and a second major side 12 (shown in FIG. 2). The base 10 comprises an upper section 14 and a lower section 16. Lower section 16 comprises an article mounting section indicated generally at 17. Finger grips 18 are found either side of the base 10 spanning upper section 14 and lower section 16. The lower section 16 carries markers 19 and 19a which indicate the central position of the article mounting section.

The article mounting section 17 found in the lower section of the base 16, comprises a socket portion 20 and a ball portion 22. Attached to the ball portion 22 is a threaded holder 24. The threaded holder 24 holds a protrusion in the form of bolt 26. Alternatively, the bolt 26 may be any suitable hook, knob, hanger, member, rod and the like from which an article (e.g., a clock, utensil, decoration etc.) can be hung or mounted. The bolt 26 could equally comprise any suitable coupling, connection, clamp, etc., that may be suitable for supporting an accessory such as a basket, tray, dish, rack, shelf, bracket, clip, etc., without departure from the mounting devices of the present disclosure.

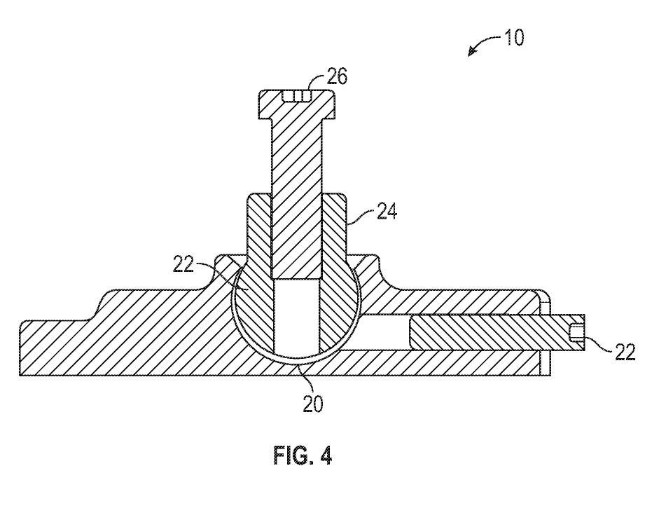

In use, the ball portion 22 may be positioned by the user as follows. The ball portion 22 is moved by the user within the socket portion 20 to the position and angle required for mounting a specific article. The ball portion 22 gives smooth rotation within the socket portion 20 as seen in FIG. 4. Once the position of ball portion 22 has been set, the position may be locked in place by a position locking mechanism. Once this position is set, the retaining screw 28 is tightened to lock the ball portion 22 into the socket portion 20. The bolt 26 is threaded into or out of the holder 24 to increase or decrease its length.

FIG. 2 shows the article support device 1 having a stretch releasable adhesive strip indicated generally at 30. The stretch releasable adhesive strip comprises two sides; a first adhesive portion 32 which can attach to a surface and a second adhesive portion 34 attached to the second base side of the article mounting device 1. The second adhesive side 32 of the adhesive strip 30 is arranged over at least a portion of the second base side 12 of the base 10. An adhesive-free pull tab portion 36 is attached to the lower half of adhesive portion 32 to aid removal of the adhesive strip 30. The stretch releasable adhesive strip 30 may be any conventionally known stretch releasable adhesive including a pressure sensitive adhesive tape having an elastic backing, a pressure sensitive adhesive tape with a highly extensible and substantially inelastic backing, or a solid, elastic pressure sensitive adhesive. Specific stretch releasable adhesive strips suitable for use in the various embodiments of the present invention include the pressure sensitive adhesives with elastic backing described in U.S. Pat. No. 4,024,312 (Korpman), the pressure sensitive adhesives with highly extensible and substantially inelastic backings described in U.S. Pat. No. 5,516,581 (Kreckel et al) and Bries et al (U.S. Pat. No. 6,231,962), and the solid, elastic pressure sensitive adhesive described in German Patent Number 3331016.

Suitable stretch releasable adhesive strips include the double-sided stretch releasable adhesive strips available from 3M Company, St. Paul, Minn. under the COMMAND trade designation.

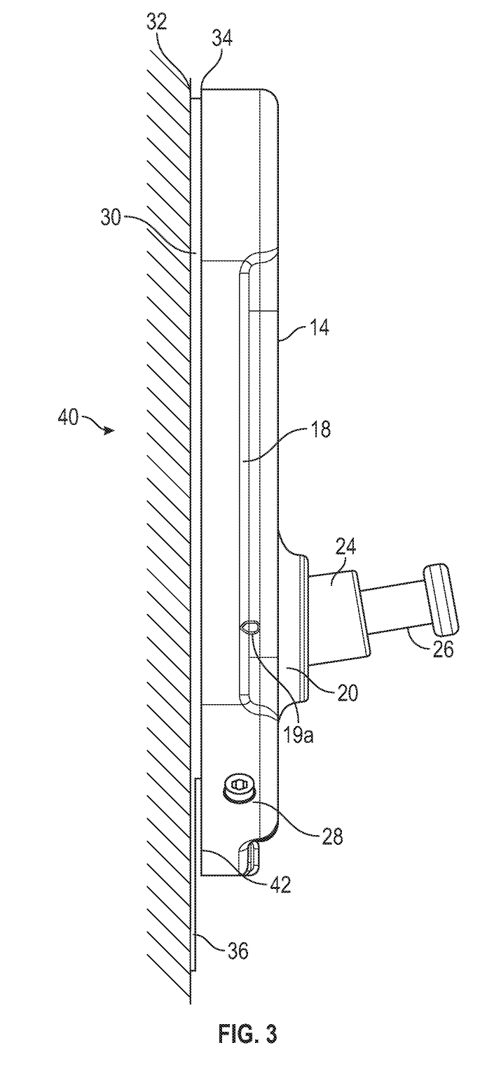

In FIG. 3, the article mounting device 1 is mounted to a surface 40 using the adhesive strip 30. At least a portion of the pull tab 36 extends downwardly beyond the lower periphery of the second base side 12. This allows the pull tab 36 to remain exposed and visible when the article mounting device 1 is attached to surface 40. The end user can then readily access pull tab 36 during the stretch removal process, following removal of the article from the article mounting device 1.

Once the article support device 1 is attached to the wall 40 as described above, the retaining screw 28 (shown in detailed cross-section in FIG. 4) is loosened to enable the user to rotate the ball portion 22 within the socket portion 20 to a position appropriate for the article. Once the position of ball portion 22 is set, the retaining screw 28 is tightened and the ball portion 22 is secured. Bolt 26 may be lengthened or shortened by the user within its threaded holder 24.

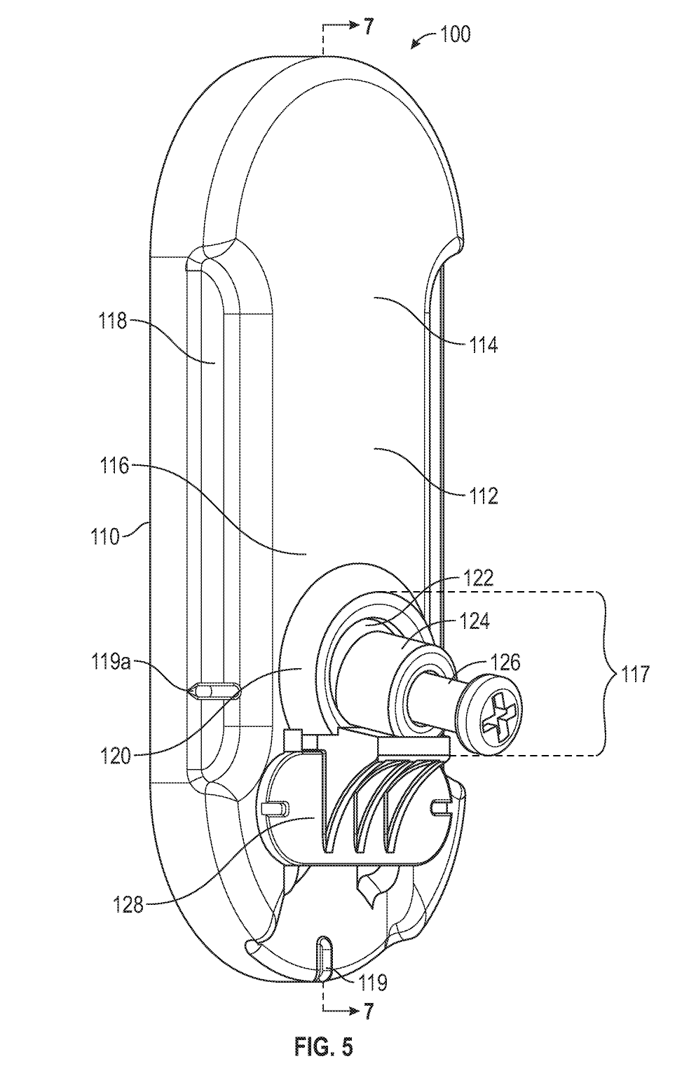

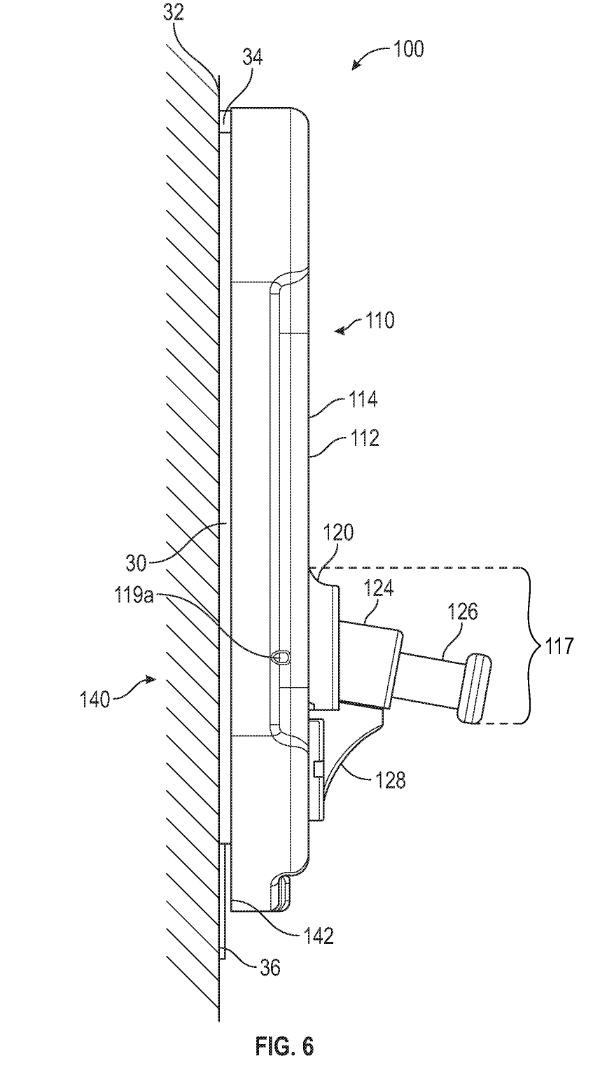

FIG. 5 shows a second embodiment of the article support device indicated generally at 100. The article support device 100 has a base 110, a first major side indicated generally at 142 and a second major side 112 (shown in FIG. 6). The base 110 comprises an upper section 114 and a lower section 116. Lower section 116 comprises the article mounting section indicated generally at 117. Finger grips 118 are found either side of the base 110 spanning upper section 114 and lower section 116. In the lower section 116, markers 119 and 119a indicate the central position of the article mounting section are indicated. The article mounting section 117 found in the lower section of the base 116, comprises a socket portion 120 and a ball portion 122. Attached to the ball portion 122 is a threaded holder 124. The threaded holder 124 holds protrusion in the form of bolt 126.

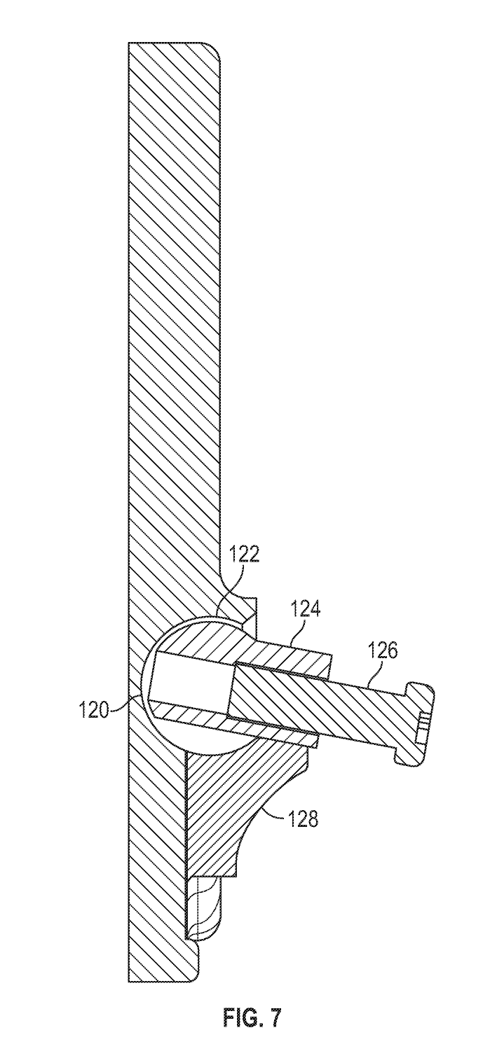

In use, the ball portion 122 may be positioned by the user as follows. The ball portion 122 is moved by the user within the socket portion 120 to the position and angle required for mounting a specific article. The ball portion 122 gives smooth rotation within the socket portion 120 as seen in FIG. 7. Once the position of ball portion 122 has been set, the position is locked in place by a position locking mechanism. The lower section of the base 116 contains a position locking mechanism in the form of a locking tab 128 which engages with the base 116 by way of a push- or snap-fit connection (which is not shown for clarity). Pushing the locking tab 128 into place engages the snap-fit connection. This causes the locking tab 128 to engage the ball portion 122 to lock the ball portion 122 into position (as shown in cross-section in FIG. 7). Bolt 126 the threaded into or out of the holder 124 to increase or decrease its length.

In FIG. 6 the article mounting device 1 is mounted to a surface 140 using the adhesive strip 30. At least a portion of the pull tab 36 extends downwardly beyond the lower periphery of the second base side 112. This allows the pull tab 36 to remain exposed and visible when the article mounting device 1 is attached to surface 140. The end user can then readily access pull tab 36 during the stretch removal process, following removal of the article from the article mounting device 1.

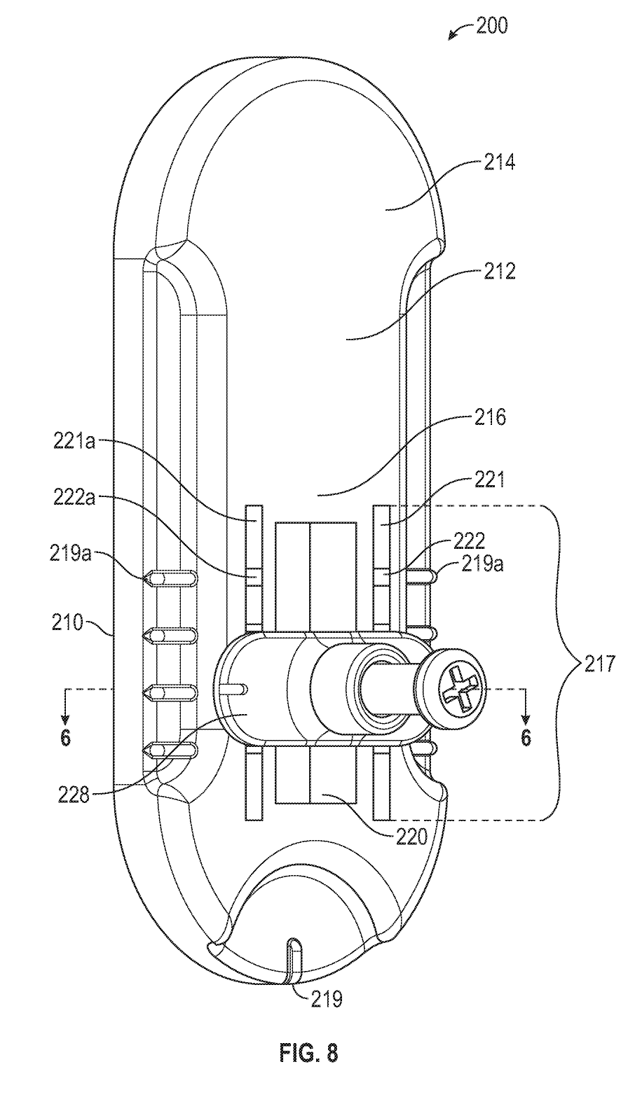

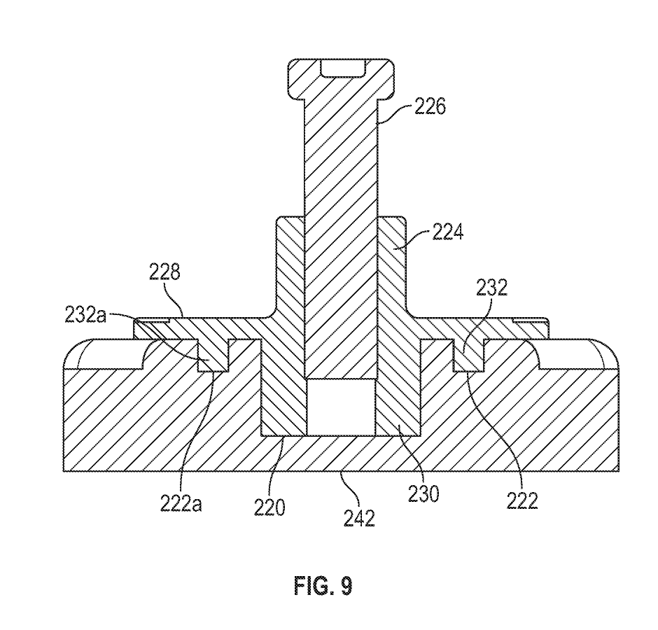

FIG. 8 shows a third embodiment of the article support device 200. The article support device 200 comprises a base indicated at 210 and a first major side indicated generally at 242 and a second major side 212 (shown in FIG. 9). The base comprises an upper section 214 and a lower section 216. Lower section 216 comprises the article mounting section indicated generally at 217. Finger grips 218 are found either side of the base 210. In the lower section 216, markers 219 and 219a indicate the central position of the article mounting section are indicated.

The embodiment of FIG. 8 differs from the earlier embodiments in that the article mounting section 217 comprises a mounting plate 228 in place of the ball and socket joints 20, 22, 120, 122 respectively.

Mounting plate 228 includes a threaded holder 224 and a bolt 226 in common with the earlier embodiments. The mounting plate 228 is mounted onto the base 210 as follows. The base defines a continuous recessed portion 220 and a pair of notched recesses. The notched recesses 221, 221a have a series of notches 222, 222a which are aligned with markers 219a.

Referring briefly to FIG. 9, the mounting plate 228 has a pair of lugs 232 and 232a and a guide portion 230. The guide portion 230 sits within the continuous recessed portion 220 to provide stability and ease of positioning. The lugs 232 and 232a engage the recesses 221 and 221a respectively.

In use, the user selects a pair of recesses 222 and 222a that are match the height required by the article. The user positions the lugs 232 and 232a on the mounting plate 228 into the selected pair of recesses 222 and 222a as shown in FIG. 9. This secures the mounting plate 228 within the base 210. Bolt 226 can be increased or decreased in length within threaded holder 224.

In order to avoid repetition the method of attaching device 200 to a surface is identical to the process described above in respect of the first and second embodiments.

What is claimed is:

1. An article mounting device, comprising:
a base having a first major side and second major side;
the first major side comprising a first major surface that is attached to a stretch releasable adhesive strip having an adhesive portion and a non-adhesive pull tab portion;
the second major side comprising a rigid protrusion for receiving an article;
wherein the protrusion is adjustable relative to the base, and wherein the protrusion has a length which is adjustable.

2. The article mounting device of claim 1 wherein the protrusion is releasably attached to an adjustable mount having a first and second portion; the first portion comprising the protrusion.

3. The article mounting device of claim 1 includes a position locking mechanism.

4. The article mounting device of claim 2 wherein the adjustable mount comprises at least one of a ball-and-socket joint and a moveable plate.

5. The article mounting device of claim 4 wherein the adjustable mount comprises a ball-and socket joint, the base comprises the socket of the ball-and-socket joint and the protrusion is attached to the ball of the ball-and-socket joint.

6. The article mounting device of claim 5 where in the protrusion is an outwardly protruding headed bolt.

7. The article mounting device of claim 3, wherein the position locking mechanism comprises a retaining screw and the ball-and-socket joint is retained in position by the retaining screw.

8. The article mounting device of claim 3, wherein the position locking mechanism comprises a locking tab and the ball and socket joint is retained in position by the locking tab.

9. The article mounting device of claim 3, wherein the position locking mechanism comprises a series of notches on the second major side of the base and wherein the moveable plate is secured into the notches.

10. (canceled)

11. The article mounting device of claim 1, wherein the second major side of the base comprises a series of markers indicating the central position of the protrusion.

12. (canceled)
